(19) United States
(12) Patent Application Publication
(10) Pub. No.: US 2007/0118607 A1
(43) Pub. Date: May 24, 2007

(54) Method and System for forensic investigation of internet resources

(75) Inventor: Niko Karl Bruno Nelissen, Gent (BE)

Correspondence Address: NIKO NELISSEN, JAN PALFIJNSTRAAT 23, GENT, 9000, BE

(73) Assignee: Niko Karl Bruno Nelissen, Gent (BE)

(21) Appl. No.: 11/164,410

(22) Filed: Nov. 22, 2005

(51) Int. Cl. G06F 15/16

(52) U.S. Cl. 709/217

(57) ABSTRACT

The present invention involves a Method and System for a forensic investigation of internet resources (IP addresses, e-mail addresses, website addresses, SSL certificates, routing table lines etc.) in order to reveal relations, dependencies and connections between these internet resources. Starting from a given internet resource, a set of examinations is performed (name server queries, Whois information lookups, initiating a connection using various protocols etc.) to retrieve background information and related internet resources. The examinations are performed recursively on the related internet resources until relevant information is found, typically contact information of a person or company owning, managing or operating an internet resource. All results are displayed in a hierarchical tree view. The invention supports investigations where the origin of internet communication (e.g. e-mail) must be determined. The invention also supports investigations where the origin, owner and location of content published on the internet must be established or where the origin of a hacking attempt or unauthorized access to a system must be determined.

### TECHNICAL FIELD OF INVENTION

The invention is in the area of forensic analysis of digital evidence accessible through the internet, originating from the internet or transmitted over the internet. The invention supports the investigation of e-mails, websites, log files and other internet resources.

### BACKGROUND OF INVENTION AND PRIOR ART

The internet is widely used as a communication channel and can easily be applied in an anonymous manner to send e-mail, to post information on a website, to communicate with other persons or to gain access to a server. The anonymous character of the internet poses a problem in a criminal investigation if the origin of an e-mail must be determined, if the actual location of illegal content must be determined—in order to have it removed—or if the origin of an intrusion attempt must be established. Further more, the complexity of the internet technology, the multitude of protocols in use and the complex relations between internet resources such as servers, makes it hard to perform an analysis of digital evidence originating from the internet. This challenge is not limited to criminal investigations. Law enforcement, private investigators, attorneys, system administrators, e-Commerce website owners and other people using the internet will at some point in time need to establish an identity of a person or company in order to have offending content removed on a website, to find the origin of an e-mail, to find the owner of a website which infringes a copyright law etc.

Current forensic methods and software available, for analysis of digital evidence, focus solely on the analysis of information stored on hard drives and other storage devices connected to a computer.

The invention presented here on the other hand, uses the internet as a source of information when analyzing digital evidence originating from the internet or digital evidence discovered on the internet.

The invention supports investigations where the origin of internet communication (e.g. e-mail) must be determined. The invention also supports investigations where the origin, owner and location of content published on the internet must be established or where the origin of a hacking attempt or unauthorized access to a system must be determined.

While prior art focuses on using a single internet protocol or database as information source to retrieve and visualize information, the present invention combines multiple sources of information to find as much information on an internet resource (e.g. e-mail address, website, domain name, IP address etc.) as possible. Further more, the novelty exists in the fact that the output information is used as input in a recursive fashion. While prior art methods require that a single internet resource be given as input, the present invention discloses a method to extract multiple internet resources automatically from a wide variety of information sources such as log files and e-mail headers and to use these internet resources as input.

### SUMMARY OF THE INVENTION

The present invention involves a Method and System for a forensic investigation of an internet resource, in order to reveal relations, dependencies and connections between this internet resource and other internet resources.

Internet resources which are subject to examination in the disclosed invention include: IP v4 (internet protocol v4) addresses, IP v6 (internet protocol v6) addresses, host names, server names, domain names, sub domains, e-mail addresses, URL's, website addresses, port numbers, name server records (DNS server records), SSL certificates, web pages, HTML code and other digital information which can be obtained through a computer network.

Starting from a given internet resource (the input internet resource), a set of examinations is performed in order to retrieve background information on said internet resource and to find related internet resources (the output internet resources). An examination can be a name server query, a lookup of Whois information, the initiation of a connection using one of various network protocols etc. The set of examinations performed on the input internet resource is determined by the type of the input internet resource.

Each of the output internet resources is considered as an input internet resource for a new set of examinations. This process of analyzing internet resources is repeated in a recursive fashion until relevant information is found. Relevant information is typically contact information of a person or company owning, managing or operating an internet resource.

The input of the present invention is not limited to singular internet resources. The input can also consist of a so called composite input internet resource. Composite input internet resources include, but are not limited to: a list of internet resources, the content of an e-mail, the content of a webpage, e-mail headers and log files.

If the input comprises e-mail headers, the individual headers are isolated and all internet resources in each of said header are isolated and analyzed by performing a set of examinations on said internet resource as described above.

If the input comprises one or more log files, the log file is parsed in order to isolate the individual logs within the log file. Each of said logs is parsed to isolate the individual log elements. Each of said log elements is parsed to retrieve internet resources within the contents of said log elements. Each of said internet resources is analyzed by performing a set of examinations on said internet resource as described above.

If the input comprises a list of internet resources of the same type, a so called bulk analysis is performed. A bulk analysis means that the same set of examinations is performed on each of the internet resources in said list.

If the input is not a singular internet resource, but said input contains one or more internet resources, for example a digital document, the input is parsed to isolate each internet resource. The parsing is executed using a regular expression. One regular expression is used for each type of internet resource. Each item in the input that matches at least one of said regular expressions, is examined by performing a set of examinations on said item.

If no internet resource is available, another Method, which is disclosed here, can be used to discover an internet resource. Said Method can be used by one person, an investigator, to discover the IP address used by a suspect, to connect to a computer network such as the internet. An investigator starts by creating a URL, called a web trap. Said URL can take any form and it should point to a specific web server, equipped to handle a web trap. Said web server is called a web trap server. The investigator will send said URL to the suspect, in order to have the suspect visit the URL. When the suspect visits the URL, the originating IP address of the HTTP request is logged on the web trap server and the web trap server responds by sending a redirect HTTP response back to the suspect, which redirects to an existing webpage on the internet. Provided that the suspect used a browser to visit the URL, the dummy webpage will be displayed in the browser of the suspect. The web trap server optionally notifies the investigator of the logged IP address and the date and time at which the IP address was logged. The investigator optionally uses said IP address as an input internet resource to perform a set of examinations on said IP address. Instead of sending back an HTTP response with a redirection, the web trap server may also respond by sending back a webpage or by sending back an HTTP error message.

### BRIEF DESCRIPTION OF THE DRAWINGS

FIG. 1 is a schematic representation of internet resources in a tree.

FIG. 2 is a schematic representation of internet resources in a tree.

FIG. 3 is a schematic representation of internet resources in a tree.

FIG. 4 is a schematic representation of internet resources in a tree where each internet resource is one node which can be expanded and collapsed.

FIG. 5 is a schematic representation of a Method to perform a set of examinations on internet resources in a recursive manner.

FIG. 6 is a schematic representation of a Method to analyze e-mail headers.

FIG. 7 is a schematic representation of a Method to analyze log files.

FIG. 8 is a schematic representation of a Method to analyze internet resources in bulk.

FIG. 9 is a schematic representation of a Method to discover the IP address of a suspect, by using a web trap.

### DETAILED DESCRIPTION OF THE INVENTION

The present invention involves a Method and System for a forensic investigation of an internet resource, in order to reveal relations, dependencies and connections between this internet resource and other internet resources.

An internet resource can be a document, a database record, a piece of digitally stored information, a software application, a service, a server or a computer; where said internet resource is connected to, available through, or part of a computer network and where said internet resource is uniquely identifiable on that computer network.

Two kinds of internet resources are distinguished in the present invention: singular input internet resources and composite internet resources. Composite internet resources are pieces of digital information that contain one or more singular internet resources within their contents.

Singular internet resources which are subject to examination in the disclosed invention include, but are not limited to: IP v4 (internet protocol v4) addresses; IP v6 (internet protocol v6) addresses; host names; server names; domain names; sub domains; e-mail address; URL's; website addresses; port numbers; name server records (DNS server records); instant messaging (chat) accounts and contacts; internet telephony accounts and contacts.

Composite internet resources which are subject to examinations in the disclosed invention include, but are not limited to: a list of singular internet resources, the body of an e-mail, the contents of a webpage, e-mail headers, the contents of log files, HTML code, e-mail headers, e-mail messages, SSL certificates, log files and other digital information which can be obtained through a computer network.

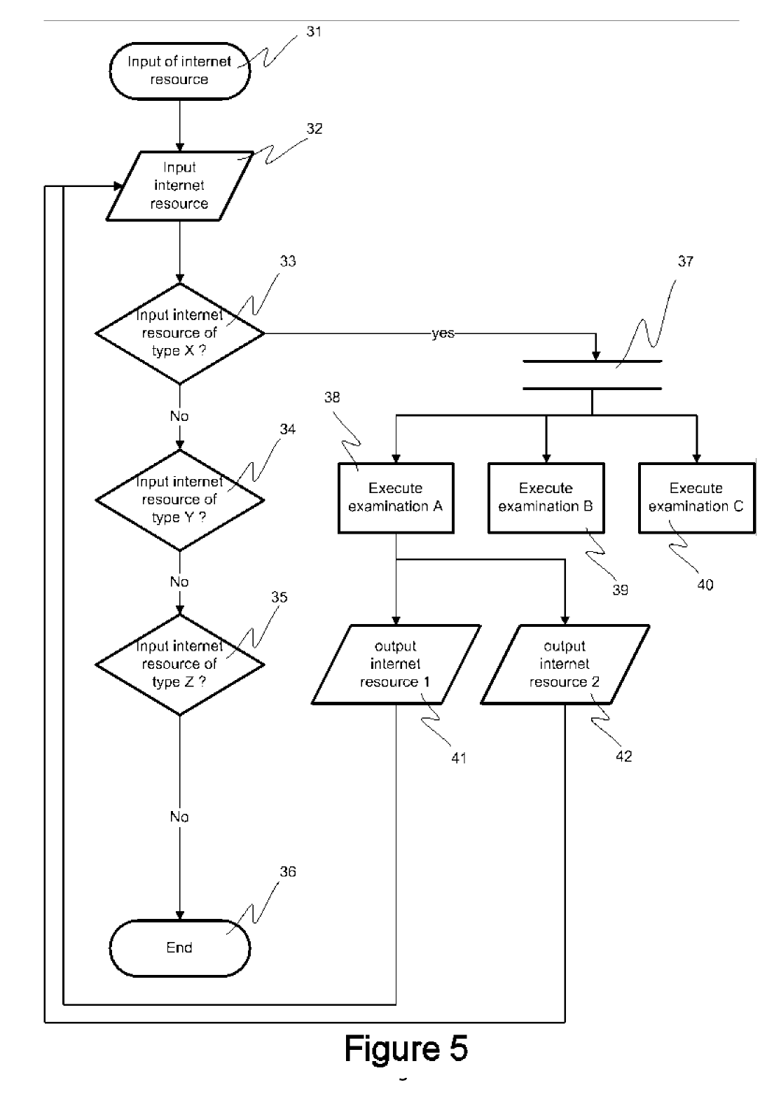

FIG. 5 provides a schematic overview of the Method disclosed here to analyze a singular internet resource. The Method starts from a given singular internet resource, represented by block 31 of FIG. 5. The given singular internet resource is used as input internet resource as shown by block 32. Depending on the type of the input internet resource, a well defined set of examinations is performed on the input internet resource. Therefore, a first test is performed on the input internet resource to decide if said internet resource is of type X. If said internet resource is indeed of type X, a set of examinations as defined for type X internet resources will be performed on the input internet resource. This is shown by blocks 33, 38, 39 and 40. The set of examinations for internet resources of type X consists of the examinations A (block 38), B (block 39) and C (block 40). If the input internet resource is not of type X, a second test is performed to decide if said internet resource is of type Y, as shown by block 34. If said internet resource is indeed of type Y, a set of examinations as defined for type Y internet resources will be performed on the input internet resource. The set of examinations for type Y internet resources are not shown in FIG. 5. This process of testing if the input internet resource is of a known type is repeated until a matching type is found. This is shown by blocks 33, 34 and 35. Blocks for additional tests are not shown in FIG. 5. If the input internet resource does not match any known type, the Method ends as shown by block 36.

The set of examinations performed on an input internet resource aims to retrieve background information on said internet resource and to find related internet resources. If the output of an examination consists of one ore more internet resources, said internet resources are called output internet resources. This is shown in FIG. 5 where examination A (block 38) produces two output internet resources, represented by blocks 41 and 42. The output internet resources of examination B (block 39) and examination C (block 40) are not shown on FIG. 5.

Each of the output internet resources is considered as an input internet resource for a new set of examinations. This is shown in FIG. 5 by the arrows from block 41 and block 42 to block 32, where the output internet resources represented by block 41 and 42 are each used as input internet resource (block 32). This process of analysing internet resources is repeated in a recursive fashion until relevant information is found. Relevant information is typically contact information of a person or a company owning, managing or operating an internet resource.

An examination can be a name server query, a lookup of Whois information, the initiation of a connection using one of various network protocols etc. Below, an overview is given of the set of examinations performed on various types of input internet resources.

If the input internet resource is any kind of domain name such as a top level domain or a sub domain thereof, said input internet resource is of type Domain following set of examinations is performed on input internet resources of type Domain:
Lookup the host name of all authoritative name servers of the input internet resource. Each host name of said authoritative name server is an output internet resource.
Lookup all host names of mail servers in the MX records in the authoritative name servers of the input internet resource. Each host name of said mail server is an output internet resource.
Lookup the Whois information of the input internet resource and retrieve all e-mail addresses from the Whois output by parsing said output. Each e-mail address found in said Whois information is an output internet resource.

If the input internet resource is any kind of computer name or server name, the input internet resource is of type Hostname following set of examinations is performed on input internet resources of type Hostname:
Extract the second level or third level domain name from the input internet resource such that the resulting domain name is a domain name registered with a registrar and for which Whois information is available. Said domain name is an output internet resource.
Lookup all IP addresses from the A records of the input internet resource, by querying the authoritative name servers of the input internet resource. Each IP address found is an output internet resource.
Lookup all host names (alias names) from the CNAME records of the input internet resource, by querying the authoritative name servers of the input internet resource. Each host name found is an output internet resource.
Convert the input internet resource to a website URL by adding “http://” in front of the host name. The resulting URL is an output internet resource.
Perform a trace route to the input internet resource. Each hop of said trace route is an output internet resource.

If the input internet resource is any kind of IP address (internet protocol address), the input internet resource is of type IP. Following set of examinations is performed on input internet resources of type IP:
Lookup the geographic location including state, country, country flag and city of the input internet resource by querying a database which contains geographical information of IP addresses.
Lookup all host names from the PTR records of the input internet resource, by querying the authoritative name servers of the input internet resource. Each host name found is an output internet resource.
Lookup Whois information of the IP block to which the input internet resource belongs and retrieve all e-mail addresses from the Whois output by parsing said output. Each e-mail address found in said Whois information is an output internet resource.
Lookup the input internet resource in a database which contains a list of known open proxies. An open proxy is a device made available on the internet which is used to connect to internet resources in an anonymous fashion.
Lookup the input internet resource in a database which contains a list of known open relays. An open relay is a server which relays e-mail messages from and to the internet in such a way that it can be used to send a large amount of unsolicited e-mails.
Check if the IP address is part of an IP range which is reserved for private networks or which is not routed on the public internet.
Perform a trace route to the input internet resource. Each hop of said trace route is an output internet resource.

If the input internet resource is any kind of e-mail address, the input internet resource is of type E-mail Address. Following set of examinations is performed on input internet resources of type E-mail Address:
Extract the domain name part from the input internet resource (the part behind the @-sign). Said domain name part is an output internet resource.
Lookup the domain name part (the part behind the @-sign) of the input internet resource in a database with known free e-mail services.
Provide a link to publicly available search engines with a predefined query to search in the content of all known websites for the input internet resource.
Provide a link to publicly available search engines with a predefined query to search in the content of all known newsgroup articles for the input internet resource.

If the input internet resource is any kind of website address or URL, the input internet resource is of type URL. Following set of examinations is performed on input internet resources of type URL:
Provide a link to the website.
Retrieve SSL certificate details and SSL certificate issuer from the input internet resource by connecting using the HTTPS protocol to the input internet resource.
Retrieve the HTML source code by querying the input internet resource using the HTTP protocol. Said HTML source code is visualized using a separate color for each type of HTML tag. Hidden information in said HTML source code is displayed in a separate color.
Parse said HTML source code for comments (text delimited by “<!--” and “-->”) and visualize said comments.
Provide a link to publicly available search engines with a predefined query to search the internet (websites and newsgroups) for links to the input internet resource.
Retrieve all web pages from the input internet resource using the HTTP protocol and by using a crawling mechanism. The crawling mechanism parses each of said web pages for links to other web pages of the same website. All web pages found are retrieved and the crawling mechanism is applied to said web pages. This process is repeated until all web pages that could be found are retrieved. The content of each of said web pages is parsed for e-mail addresses. Each e-mail address found is an output internet resource. The content of each of said web pages is parsed for links to other websites. Each link found is an output internet resource.
Provide a link to publicly available search engines with a predefined query to search the internet for websites related to input internet resource.
Provide a link to publicly available search engines with a predefined query to search said search engine for all web pages of input internet resource.

In addition to the examinations disclosed here, any examination can be performed on an input internet resource if the examination provides human readable textual or numeric output which provides new information on the input internet resource or if the examination provides one or more output internet resources which may or may not be subject to being an input internet resource for a new set of examinations.

It is apparent to those skilled in the art, that other examinations on an internet resource may be used in the Method disclosed here, including, but are not limited to: operating system fingerprinting; service and software fingerprinting; steganography; test if two IP addresses are used by the same physical server or servers; AS (autonomous system) trace; real-time open proxy check; real-time open relay check; e-mail author identification or attribution etc.

In addition to the fact that the examinations disclosed here are performed on one specific type of input internet resource, each of said examinations can also be performed on other types of internet resources, provided that the examination produces output which reveals new information on the input internet resource.

In addition to singular internet resource, composite internet resources can also be used as input. The present invention discloses a Method to analyze various types of composite internet resources including e-mail headers, log files and other composite internet resources.

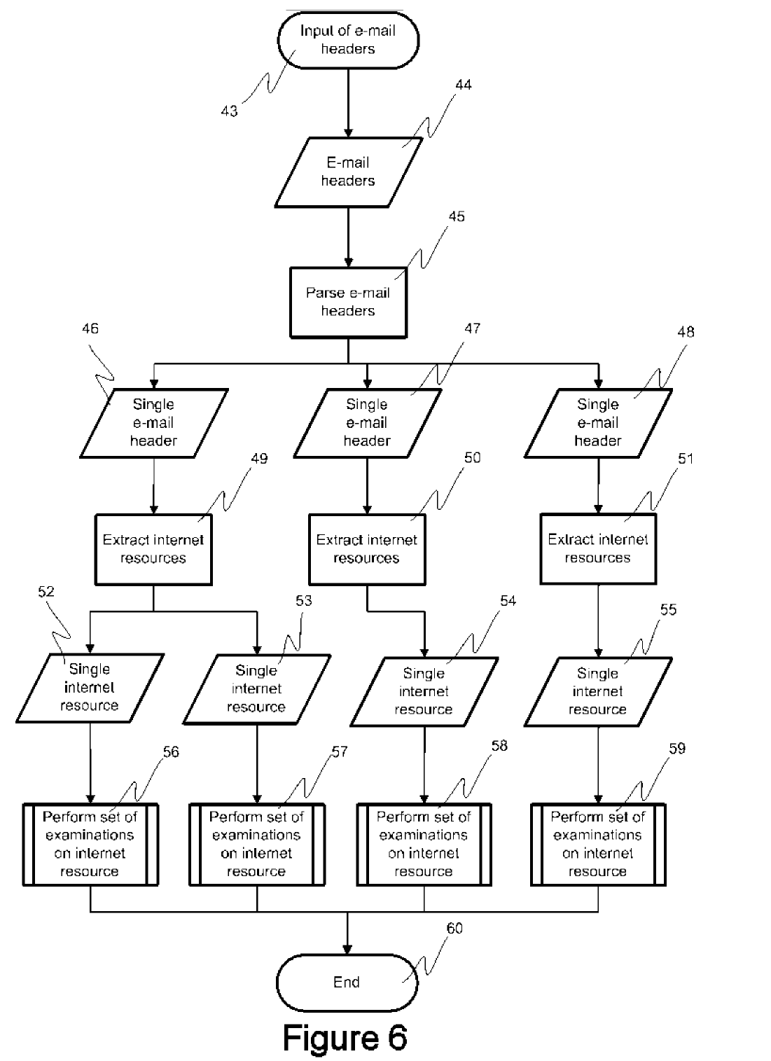

FIG. 6 shows a schematic diagram of the Method disclosed here to analyze e-mail headers. Headers are added to an e-mail by the SMTP (Simple Mail Transfer Protocol) servers sending, forwarding and receiving said e-mail. The input of the Method disclosed here consists of the e-mail headers of one e-mail message or a part of the e-mail headers of one e-mail message, as shown by block 43 and block 44. Next, the e-mail headers are considered as a composite internet resource. The e-mail headers are therefore parsed as represented by block 45, in order to retrieve the individual headers which are added by each SMTP server. The result of this parsing are the individual e-mail headers as represented by blocks 46, 47 and 48. The number of individual e-mail headers may vary. From each of said individual e-mail headers, the internet resources contained in the e-mail header are extracted as represented by blocks 49, 50 and 51, by parsing the e-mail header. The result of this parsing is zero, one or more singular internet resources such as server names, IP address, domain names, e-mail addresses and other singular internet resources. Each of these singular internet resources (represented by blocks 52, 53, 54 and 55) is used as input for the Method represented in FIG. 5. This is shown by blocks 56, 57, 58 and 59, which are all a representation for the whole Method represented in FIG. 5. For example the singular internet resource represented by block 52 (FIG. 6) will be used as the input internet resource, represented by block 32 in FIG. 5. The Method will test the type of this input internet resource as represented by blocks 33, 34 and 35. Depending on the type of said input internet resource (which was retrieved from one of the individual e-mail headers), a certain set of examinations will be performed on the internet resource, as represented by blocks 38, 39 and 40. The output internet resources of said examinations will be used in turn as input internet resource by applying the Method shown in FIG. 5 in a recursive fashion.

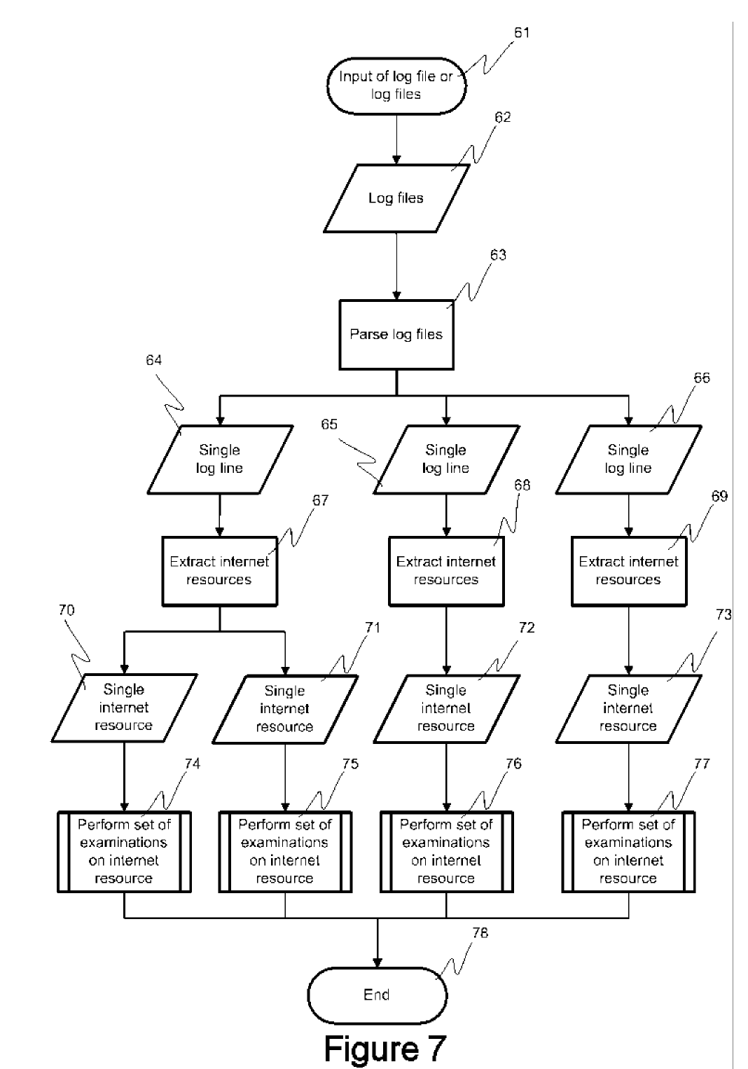

FIG. 7 shows a schematic diagram of the Method disclosed here to analyze log files. Log files contain logged information from actions and transactions performed by software or a service, running on a computer or server. Log files which can be analyzed using the Method disclosed here include, but are not limited to: log files of mail servers where said log files contain a log for each e-mail message received by, forwarded by or sent by said mail server; log files of web servers where said log files contain a log for each HTTP request received by and each HTTP response sent by said web server; log files of web servers where said log files contain a log for each request of a web page on said web server; log files of FTP servers where said log files contain a log for each connection made to and each request sent to and each response sent by said FTP server. The Method disclosed here takes the contents of one or more log files or part of a log file as input, as shown by blocks 61 and 62. Next, the input is parsed as shown by block 63, in order to retrieve the individual logs contained within said log file or log files. The individual logs are represented by blocks 64, 65 and 66. The actual number of logs may vary and can be as high as 10,000 or 100,000 or more individual logs. If the log files are comprised of digital files in plain text format, an individual log usually corresponds to a singular line in said file. Each individual log is parsed as shown by blocks 67, 68 and 69 in order to retrieve all singular internet resources contained within said log. The internet resources found by parsing each log are represented by blocks 70 ,71, 72 and 73. The number of internet resources found in each log may vary. Each of said internet resources (including but not limited to: e-mail addresses, IP addresses, host names, domain names, URL's) is used as an input internet resource for the Method shown in FIG. 5. This is shown by blocks 74, 75, 76 and 77, which are all a representation for the whole Method represented in FIG. 5. For example the singular internet resource represented by block 70 (FIG. 7) will be used as the input internet resource, represented by block 32 in FIG. 5. The Method will test the type of this input internet resource as represented by blocks 33, 34 and 35. Depending on the type of said input internet resource, a certain set of examinations will be performed on the internet resource, as represented by blocks 38, 39 and 40. The output internet resources of said examinations will be used in turn as input internet resource by applying the Method shown in FIG. 5 in a recursive fashion.

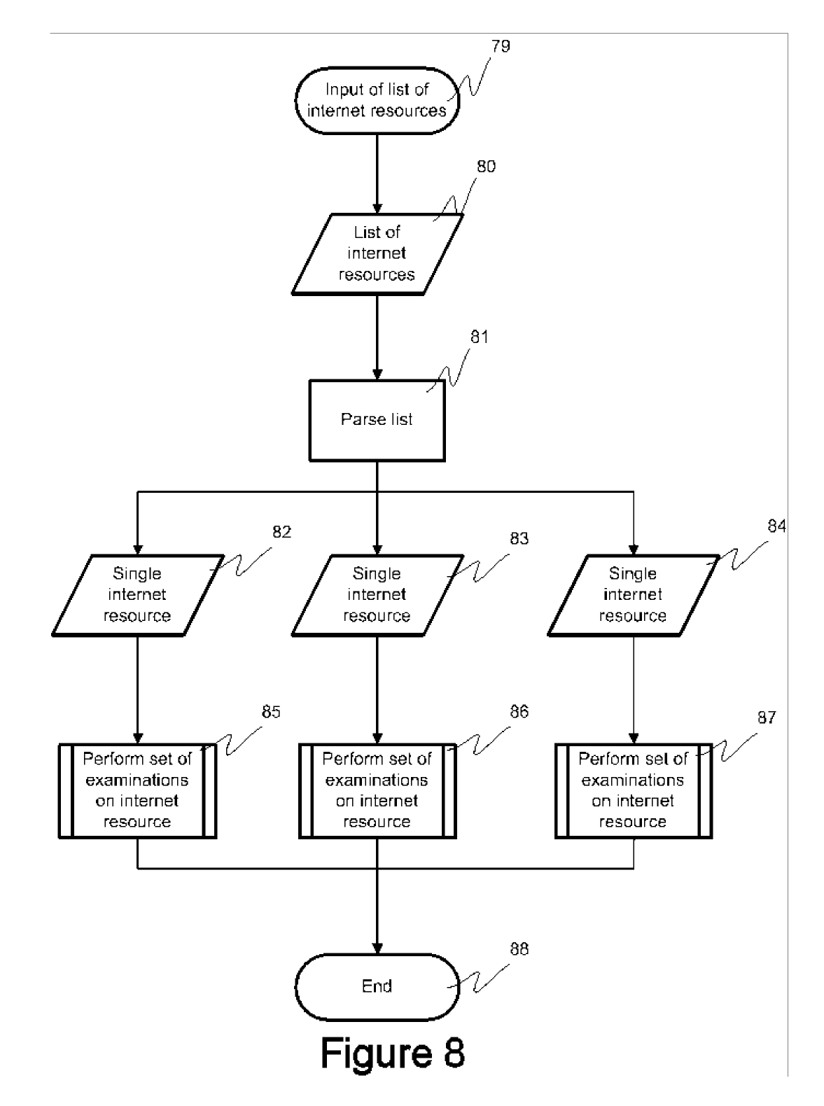

FIG. 8 shows a schematic diagram of the Method disclosed here to perform a bulk analysis on a list of internet resources of the same type or of different types. The Method disclosed here takes a list of singular internet resources as input, as shown by blocks 79 and 80. Next, said list is parsed in order to isolate each individual internet resource, as shown by block 81. The output of said parsing is a set of internet resources, represented by blocks 82, 83 and 84. The actual number of internet resources may vary. Each of said internet resources (including but not limited to: e-mail addresses, IP addresses, host names, domain names, URL's) is used as an input internet resource for the Method shown in FIG. 5. This is shown by blocks 85, 86 and 87, which are all a representation for the whole Method represented in FIG. 5. For example the singular internet resource represented by block 82 (FIG. 8) will be used as the input internet resource, represented by block 32 in FIG. 5. The Method will test the type of this input internet resource as represented by blocks 33, 34 and 35. Depending on the type of said input internet resource, a certain set of examinations will be performed on the internet resource, as represented by blocks 38, 39 and 40.

If the input of one of the Methods disclosed in present invention is a not a known singular or composite internet resource, but said input contains one or more internet resources (for example a digital document), the input is parsed in order to isolate each internet resource. The parsing is executed using regular expressions. One regular expression is used for each type of singular internet resource. Each item in the input that matches at least one of said regular expressions, is used as input internet resource for the Method shown in FIG. 5. A set of examinations will be performed on said internet resource in a recursive fashion.

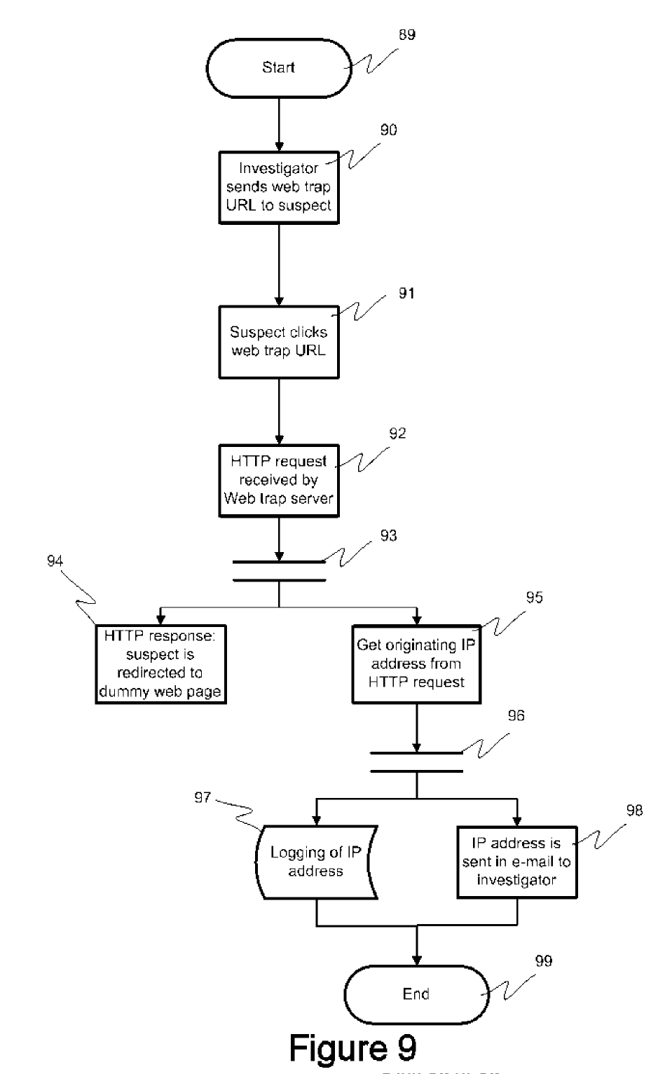

In many circumstances an internet resource (for example an IP address) is available and can be used as an input for an analysis as disclosed here. If on the other hand no internet resource is available, another Method, which is disclosed here, can be used to discover an internet resource. The Method disclosed here is schematically shown in FIG. 9 and can be used by a person (further on referred to as an investigator) to discover the IP address which is used by another person (further on referred to as a suspect) to connect to a computer network such as the internet. The investigator starts by creating a URL, further on referred to as a web trap. Said URL can take any form and it should point to a specific web server, equipped to handle a web trap. Said web server is further on referred to as a web trap server. The investigator will send said URL to the suspect or otherwise deliver the URL to the suspect as shown by block 90, in order to have the suspect click or visit the URL. When the suspect clicks or visits the URL as shown by block 91, an HTTP request is sent from the computer of the suspect to the web trap server as shown by block 92. Without the knowledge of the suspect, the originating IP address is retrieved from the HTTP request (block 95) and said IP address is logged on the web trap server (block 97), by storing it in a file or a database system or by storing it in any other form on a digital storage device. The web trap server responds to the HTTP request by sending a redirect HTTP response back to the suspect (block 94), which redirects to an existing webpage on the internet, further on referred to as a dummy webpage. Provided that the suspect used a browser to visit the URL, the dummy webpage will be displayed in the browser of the suspect. The web trap server optionally notifies the investigator of the logged IP address and the date and time at which the IP address was logged (block 98). The investigator optionally uses said IP address as an input internet resource to perform a set of examinations on said IP address using the Method shown in FIG. 5. Instead of sending back an HTTP response with a redirection, the web trap server may also respond by sending back a webpage or by sending back an HTTP error message.

Besides the Method disclosed here, the current invention also involves a System which implements said Method. The functionality implemented by the System disclosed in this invention includes, but is not limited to: the ability to enter one or more singular or composite input internet resources; the ability to start examinations on an input internet resource; the ability to perform examinations iteratively on output internet resources in an automated or interactive fashion; the ability to display the results of the examinations on a computer screen; the ability to save the results of the examinations on a digital storage medium such as a hard drive or file server; the ability to export the results in various file formats including but not limited to graphical file formats, textual formats and database formats; the ability to generate human readable reports based on the results of the examination; the ability to schedule automated examinations; the ability to read input internet resources from a digital file; the ability to parse said input and retrieve all internet resources contained in the input; the ability to print the results of the examinations and reports on paper.

The System implements the Method which is presented schematically by FIG. 5. The System takes an internet resource as input and performs a set of examinations on the input internet resource. The resulting output internet resources are in turn examined in a recursive fashion.

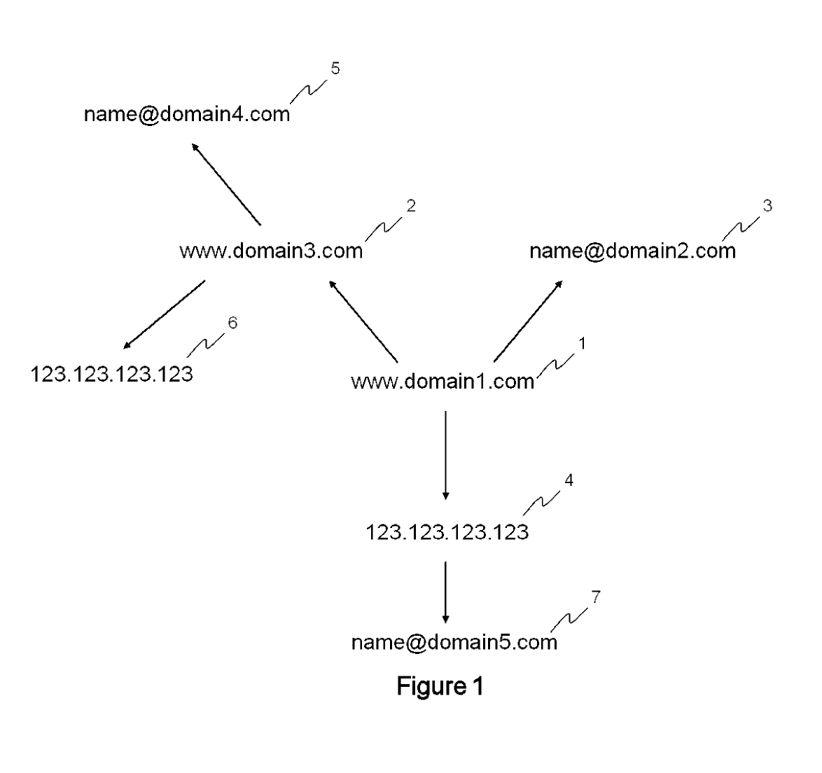

The System displays the results of all the examinations in a hierarchical tree. The tree can be represented in various ways, as shown by the examples in FIGS. 1, 2, 3 and 4. The tree starts with the input internet resource as root node. The output internet resources are added as child to the root node. Each output internet resource is in turn examined and the resulting output internet resources are added as child nodes.

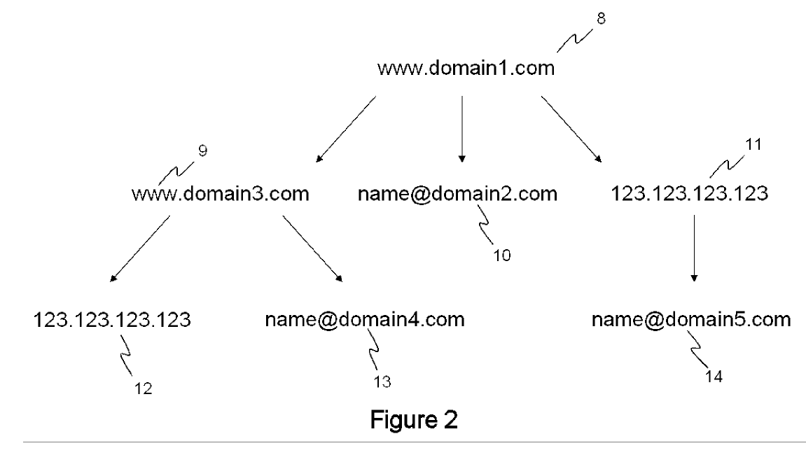

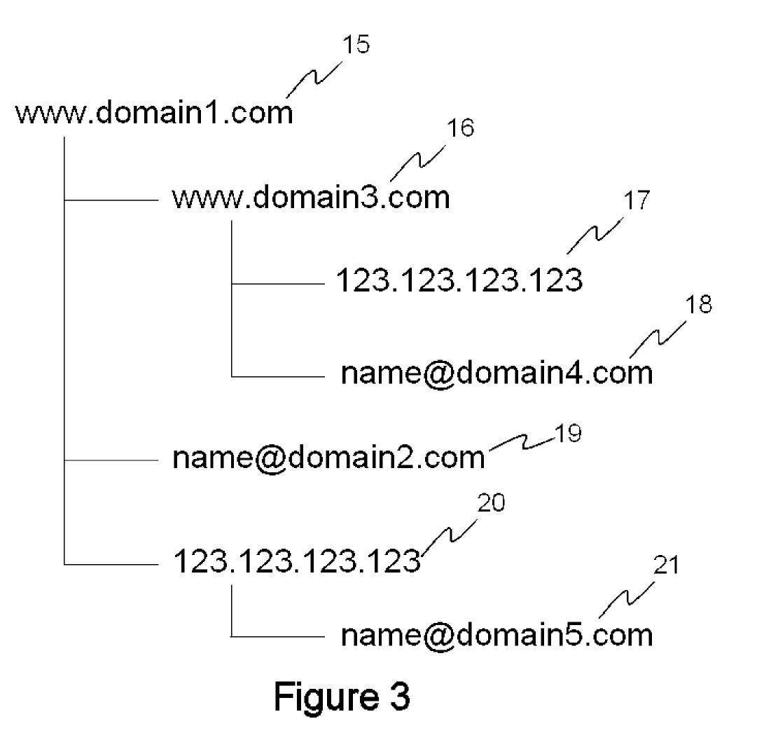

FIG. 1 shows an example. The input internet resource (the input to the System) is the URL www.domain1.com [1]. A set of examinations is performed on the input internet resources. The output internet resources of said examinations are the host name www.domain3.com [2] (e.g. retrieved from the CNAME record in the DNS servers), the e-mail address name@domain2.com [3] (e.g. retrieved from the Whois information of the domain name domain1.com) and the IP address 123.123.123.132 [4] (e.g. retrieved from an A record in the DNS servers). A set of examinations is performed on internet resource [2] and the output internet resources are [5] and [6]. A set of examinations is performed on internet resource [4] and the output internet resource is [7]. FIGS. 2 and 3 show the same example where the tree is displayed in a different fashion.

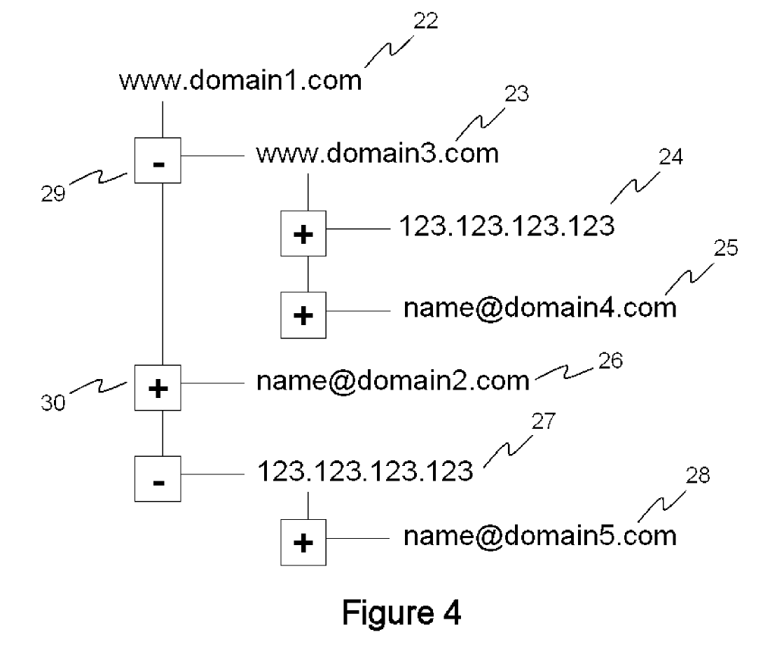

Each internet resource in the tree is a node which can be expanded. By expanding a node of an internet resource, a set of examinations is performed on said internet resource and the results are added as new child nodes to said node. This allows for an interactive analysis where the examinations are started by the user of the System. One possible implementation of this System is shown by FIG. 4. In front of all tree nodes a plus icon [29] or minus icon [30] is displayed. By selecting a plus icon of a node, the node is expanded and this will initiate a set of examinations on said node. By clicking a minus icon, an expanded node is collapsed.

The representation of internet resources in a tree can further be enhanced by adding examination nodes to the tree. The examination nodes display information of the examination which is performed on an internet resource node. For each examination which is performed on an internet resource, one examination node is added as child to the internet resource node. The output internet resources of said examination are in turn added as child nodes to the examination node.

An examination node can contain any of following pieces of information: a descriptive title of the examination (e.g. “lookup of A records in name servers”); an icon indicating the type of examination; a description of the examination (“A records convert host names to IP addresses”); background information on the input internet resource which is revealed through the examination (e.g. “This IP address does not have any A records”); a description explaining the relationship between the input internet resource and the output internet resources; a description of the context in which the input internet resource was examined.

Further more, the System disclosed here implements the Method, represented schematically by FIG. 6, to analyze e-mail headers. The user can input a set of e-mail headers into the System and start an automated analysis. The e-mail headers are parsed and visualized as a list of individual headers. The headers visualized in said list are sorted in chronological order. For each header, following background information is displayed (provided that the information is present in said e-mail header): the host name and the IP address of the sending mail server (the mail server from which the e-mail is received), the host name and the IP address of the receiving mail server (the mail server by which the e-mail is received), the date and time of creation of the e-mail header, a list of internet resources found in the header. Each of said internet resources is used as an input internet resource for the Method shown in FIG. 5, and through this Method, said internet resource is subject to a set of examinations. The internet resources are displayed in a tree and each internet resource is a node of said tree. The nodes of the tree can be expanded to reveal the child nodes, which are the output internet resources of the examinations performed on said node.

Further still, the System disclosed here implements the Method, represented schematically by FIG. 7, to analyze log files. The user can input one or more log files into the System and start an automated analysis. The log files are parsed into single logs. The log file is displayed in a grid in which each row corresponds to a single log. The individual logs are parsed into log elements. Log elements in a log are delimited using a single character (for example a space, a comma, a colon, a semi colon, a pipe character) or a set of characters (for example a quote before and after each log element and/or a comma or space in between the quotes). The log elements of each log are displayed in separate columns. Internet resources contained within the log elements are displayed in a different color to the rest of the contents of said log elements. Each of said internet resources can be used as an input internet resource for the Method shown in FIG. 5, and through this Method, said internet resource will be subject to a set of examinations. The user can trigger the execution of the examinations by selecting the internet resource.

Further still, The System involved in the present invention implements the Method, represented schematically by FIG. 8, to perform a bulk analysis on a list of internet resources. The user can input a list of internet resources into the System and start an automated analysis. The list is parsed into singular internet resources. On each of the internet resources, a set of examinations is performed according to its type. The same sets of examinations are used as the examinations used in the Method represented by FIG. 5. The System displays a grid for each type of internet resource. In the grids, a row corresponds to a singular internet resource. In each column of the grids, the results of one examination are displayed. For example if the input list consists of a set of IP addresses, the grid of IP addresses may consist of following columns (non limiting list): input IP address; State of geographical location of IP address; Country of geographical location of IP address; City of geographical location of IP address; Owner name from Whois database; Owner e-mail from Whois database; Reverse lookup (PTR record) from DNS servers. Each internet resource displayed in the grid (whether it is an input internet resource or an output internet resource), can be selected to start a recursive analysis on this internet resource using the Method represented by FIG. 5.

Further still, The System involved in the present invention implements the Method, represented schematically by FIG. 9, to discover the IP address of a suspect by creating a web trap. Using the System, the investigator first builds a web trap URL by selecting one URL, domain name or IP address from a list. Each URL, domain name and IP address in said list is configured in the name servers so it points to the web trap server. The investigator optionally adds a path and web page name to the URL. The web trap server runs a web server software which is configured to accept any HTTP request regardless of the path and web page in the HTTP request. The investigator sends the URL to a suspect, typically in an anonymous fashion. If the suspect clicks the URL or otherwise visits the URL, the HTTP request is received by the web trap server. The web trap server will log the IP address of the origin of the HTTP request in a file or database system and it will send back an HTTP response to the suspect with a redirect to a dummy web page or with a dummy web page within the HTTP response or with an HTTP error in the HTTP response. This logic is implemented in a CGI script or a dynamic web page. Said CGI script or dynamic web page is part of the System disclosed here. The System disclosed here optionally notifies the investigator by e-mail or otherwise, of the fact that the web trap was visited. Said notification optionally contains the time and date of the visit and the originating IP address of said visit. Using the System disclosed here, the investigator can see all web traps he or she configured and per web trap a log of all visits to said web trap. Any internet resource within said log (including but not limited to: the originating IP address of the visit to the web trap) can be used as an input internet resource for the Method shown in FIG. 5, and through this Method, said internet resource will be subject to a set of examinations. This functionality allows the investigator to find new information on the internet resource, for example the geographic location of the IP address and the organization owning or managing the IP address.

The System can be implemented in various ways. Firstly, the System can be implemented as a web based service which is made available on the public internet or on a private network. Secondly, the System can be implemented as a stand alone application on a computer system where all examinations are performed from the computer on which the System operates. Thirdly, the System can be implemented as a client/server architecture where all examinations are performed from a server with access to the public internet and where the results are displayed in a remote client. Fourthly, the System can be implemented as a ready to use appliance. Other implementations of the System are also possible.

The Method and System disclosed here can be used, among other things, to identify directly or indirectly:
The originating computer, server, network, IP address, geographical location (city, country), datacenter, hosting provider, service provider and/or sender of blackmail or unsolicited commercial e-mail (spam) or any e-mail message which is considered evidence in a criminal or forensic investigation or any e-mail message which is subject to an investigation by a private investigator or a law enforcement officer or an enterprise involved in e-Commerce.
The computer, server, network, IP address, geographical location (city, country), datacenter, hosting provider, service provider, person, company and/or organization hosting, owning, maintaining or operating a webpage or website, on which illegal content is displayed or otherwise made available or any website or part thereof which is considered evidence in a criminal or forensic investigation.
The computer, server, network, IP address, geographical location (city, country), datacenter, hosting provider, service provider, person, company and/or organization from which or using which an intrusion or intrusion attempt or unauthorized access or hacking attempt was performed on a computer or server or online service or database or software or digital information or network.
The IP address of an anonymous person who communicates over the internet.

What is claimed is:

1. A method to perform one or more examinations on an input internet resource; where the result of each of said examinations is comprised of zero or more output internet resources or textual information or graphical information; where each of said output internet resources is used as input for one or more examinations using said method; where said method is applied on output internet resources acting is input internet resources in a recursive fashion; where said method reveals relations, dependencies and connections between internet resources; where said method reveals background information on internet resources; where said background information comprises contact information of a person or company owning, managing or operating said internet resource.

2. A method according to claim 1, where said input internet resource is selected from the group consisting of a domain name and a host name and a server name and a name server record and an internet protocol address and an e-mail address and a website address and a unified resource locator.

3. A method according to claim 1, where one of said examinations comprises querying name servers for records containing said input internet resource; where each host name and each internet protocol address contained in said records is an output internet resource.

4. A method according to claim 1, where one of said examinations comprises the steps of:
retrieving the whois information of said input internet resource;
retrieving all e-mail addresses from said whois information by parsing said whois information; where each of said e-mail addresses is an output internet resource.

5. A method according to claim 1, where one of said examinations comprises performing a trace route to said input internet resource; where each resulting hop of said trace route is an output internet resource.

6. A method according to claim 1, where one of said examinations comprises extracting the domain name part from said input internet resource; where said domain name part is an output internet resource.

7. A method according to claim 1, where one of said examinations comprises looking up said input internet resource in one or more databases; where said databases are selected from the group consisting of a database containing open proxy servers and a database containing open relay servers and a database containing the geographical location of internet resources.

8. A method according to claim 1, where the input internet resource is a URL or website address and where one of said examinations consists of a crawling mechanism; where said crawling mechanism consists of retrieving the web page linked to by said input internet resource using the HTTP protocol; where said crawling mechanism parses said web page for hyperlinks to other web pages of the same website; where all web pages linked to by said hyperlinks are retrieved using said crawling mechanism; where said crawling mechanism is applied to each of said web pages in a recursive fashion; where said crawling mechanism is repeated until all web pages that could be found are retrieved; where subsequently the content of each of said web pages is parsed for e-mail addresses; where each of said e-mail addresses is an output internet resource; where the content of each of said web pages is parsed for hyperlinks to other websites; where each hyperlink found is an output internet resource.

9. A method for extracting internet resources from a set of e-mail headers, said method comprising the steps of:
extracting the individual e-mail headers from said set of e-mail headers;
extracting from each of said individual e-mail headers all internet resources by parsing said individual e-mail headers; where each of said internet resources is used as an input internet resource to perform a set of examinations according to claim 1.

10. A method for extracting internet resources from one or more log files, said method comprising the steps of:
extracting the individual logs from said log files;
extracting from each of said individual logs all internet resources consisting of a server name, an IP address, a domain name or an e-mail address, by parsing said individual logs; where each of said internet resource is used as an input internet resource to perform a set of examinations according to claim 1.

11. A method applied by an investigator for discovering the IP address used by a suspect to connect to a computer network such as the internet, said method comprising the steps of:
the investigator creating a URL of any form, pointing to a specific web server equipped to log visits to said URL;
the investigator sending said URL to the suspect, in order to have the suspect visit the URL;
when the suspect visits the URL, the originating IP address of the HTTP request being logged;
the web server responding by sending a redirect HTTP response back to the suspect, which redirects to an existing webpage on the internet;
the investigator being notified of the logged IP address and the date and time at which said IP address was logged;
the investigator using said IP address as an input internet resource to perform a set of examinations on said IP address according to claim 1.

12. A computer program product stored on a computer-usable medium comprising computer-readable program means for causing said computer to perform the steps of claim 1.

13. A system to perform one or more examinations on an input internet resource; where the result of each of said examinations is comprised of zero or more output internet resources or textual information or graphical information; where each of said output internet resources is used as input for one or more examinations using said method; where said method is applied on output internet resources acting is input internet resources in a recursive fashion; where said method reveals relations, dependencies and connections between internet resources; where said method reveals background information on internet resources; where said background information comprises contact information of a person or company owning, managing or operating said internet resource.

14. A system according to claim 13 where the results of said examinations are visualised in a tree; where each input internet resource is a node in said tree; where each output internet resource is a child node of said node; where each child node may have other child nodes; where each node can be expanded or collapsed; where expanding the node of an internet resource triggers the execution of a set of examinations on said internet resource; where the results of said examinations are displayed as new child nodes of the node of said internet resource.
